(19) United States
(12) Patent Application Publication
(10) Pub. No.: US 2007/0234132 A1
(43) Pub. Date: Oct. 4, 2007

(54) SYSTEM AND METHOD FOR INDICATING ERRORS OF A MOTHERBOARD

(75) Inventor: MING-CHE LEE, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/614,992

(22) Filed: Dec. 22, 2006

(30) Foreign Application Priority Data
Mar. 29, 2006 (CN) 200610060101.3

(51) Int. Cl. G06F 11/00

(52) U.S. Cl. 714/57

(57) ABSTRACT

An exemplary method for indicating errors of a motherboard is provided. The method includes: setting a flicker count for indicating different error types occurred on a motherboard, and inserting the flicker count and corresponding error types in an error information index; resetting or clearing statuses information of the motherboard from the previous power-on self-test within the computer; performing a power-on self-test on the computer, and storing status information of the motherboard generated during the power-on self-test; detecting whether the motherboard has any error according to the status information of the motherboard; reading information of the error and corresponding flicker count from the error information index if the motherboard has any error; and flickering a light device according to the flicker count. A related system is also provided.

### BACKGROUND OF THE INVENTION

1. Field of the Invention

The present invention relates to a system and method for detecting and indicating errors of a motherboard.

2. Description of Related Art

As computers are adopted for an increasing number of applications, a complexity of the computers has increased significantly that most users are unfamiliar with the internal design and configuration of the computers used today. Consequently, when a computer fails due to failures of components in the computer, the user is often unable to determine the source of the problem and how to resolve the problem. Various means are provided to enable a user to try to resolve computer problems. Current personal computers are typically equipped with some forms of internal diagnostic tools to detect and isolate component faults within the personal computer. For instance, a diagnostic tool may consist of a series of instructions executed by the central processing unit (CPU) within the personal computer to allow self-diagnosis. Such diagnostic tool may test and report on operational statuses or functionality of components within the personal computer.

Diagnostic tools may be embedded in a nonvolatile memory. One type of embedded diagnostic tools is the power-on self-test (POST) diagnosis program, generally stored in a basic input-output system (BIOS) ROM in personal computers. The POST includes a series of test programs that a computer performs on its components each time the computer is powered on. The POST begins by reading system configuration information that has either been hard-wired or stored in a nonvolatile memory. It then checks a random access memory (RAM) by writing to and reading from the RAM to ensure proper operation. The POST next examines external disk drives to confirm that they match the system configuration information. Lastly, the POST initiates boot sequences to load the operating system.

However, in order for the user to utilize diagnostic information from execution of the POST, certain components of a computer such as a central processing unit (CPU), data buses, bus controller and the like must be functional. Some failures may occur before those components fully function, resulting in the BIOS ROM to be unable to provide the POST routines to the CPU. As a result, the POST may not diagnose any failures. For example, in the event of a blank screen of a computer, the user may suspect a failure on the motherboard. However, the user may not be sure of the failure on the motherboard since the event occurs before the POST diagnosis are available. The user may have to assume that it could be a failure of the motherboard, a failure of any one of the devices on a peripheral card, a fault occurring in any one of the slots or the like, which may also render the CPU unable to retrieve further instruction of the POST.

What is needed, therefore, is a system and method for indicating errors of a motherboard within a computer, and further indicating the failure components or assemblies of a motherboard via a flickering light emitting diode (LED).

### SUMMARY OF THE INVENTION

A system for indicating errors of a motherboard is provided in accordance with a preferred embodiment. The system includes a light device, a light configuration module, a processing module, a determining module, a reading module, and a light device controller module. The light device is electrically connected to the motherboard and configured for flickering when error occurs on the motherboard. The light configuration module is configured for setting a flicker count for indicating different error types occurred on the motherboard, and inserting the flicker count and corresponding error types in an error information index. The processing module is configured for resetting or clearing statuses information of the motherboard from the previous power-on self-test, performing a power-on self-test on the computer, and storing status information of the motherboard generated during the power-on self-test. The determining module is configured for detecting whether the motherboard has any error according to the status information of the motherboard. The reading module is configured for reading information of the error and the flicker count corresponding to the error from the error information index if the motherboard has any error. The light device controller module is configured for controlling a light device to flicker according to the flicker count.

A method for detecting and indicating errors of a motherboard is disclosed. The method includes: setting a flicker count for indicating different error types occurred on a motherboard, and inserting the flicker count and corresponding error types in an error information index; resetting or clearing statuses information of the motherboard from the previous power-on self-test within the computer; performing a power-on self-test on the computer, and storing status information of the motherboard generated during the power-on self-test; detecting whether the motherboard has any error according to the status information of the motherboard; reading information of the error and corresponding flicker count from the error information index if the motherboard has any error; and flickering a light device according to the flicker count.

Other systems, methods, features, and advantages of the present invention will be or become apparent to one with skill in the art upon examination of the following drawings and detailed description.

### BRIEF DESCRIPTION OF THE DRAWINGS

FIG. 1 is a schematic diagram illustrating an application environment of a system for indicating errors of a motherboard in accordance with one preferred embodiment;

FIG. 2 is a schematic diagram of software function modules of the BIOS memory of FIG. 1;

FIG. 3 is a schematic diagram of an error information index of the system of FIG. 1;

FIG. 4 is a flowchart of a preferred method for indicating errors of a motherboard in accordance with another embodiment; and

FIG. 5 is one step of FIG. 3 in detail, namely flickering according to a flicker count.

### DETAILED DESCRIPTION OF THE INVENTION

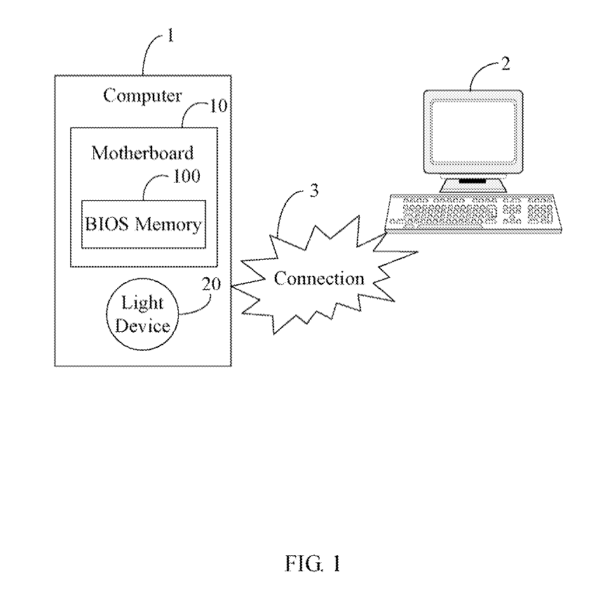

FIG. 1 is a schematic diagram illustrating an application environment of a system for indicating errors of a motherboard (hereinafter, “the system”) in accordance with one preferred embodiment. The system is implemented with a computer system. The computer system may typically include a computer 1 and a liquid crystal display (LCD) 2. The computer 1 is connected with the LCD 2 via a connection 3. The LCD 2 is configured for displaying pictures when the computer system is powered on.

The computer 1 includes a motherboard 10, and a light device 20. The light device 20 is coupled to the motherboard 10 and adopted for indicating when the motherboard 10 is powered on. In the preferred embodiment, the light device 20 is a light emitting diode (LED). The LED may be positioned on the front panel of the LCD 2. Alternatively, the LED may even be positioned to be in plain sight externally. The light device 20 is further configured to flicker when a component error or an assembly error occurs. The motherboard 10 typically includes a basic input output system (BIOS) memory 100 such as a BIOS read only memory (BIOS ROM) or a BIOS random access memory (BIOS RAM). The BIOS memory 100 is configured for storing diagnostic instructions as well as bus management instructions, bootstrap initialization instructions, and the like.

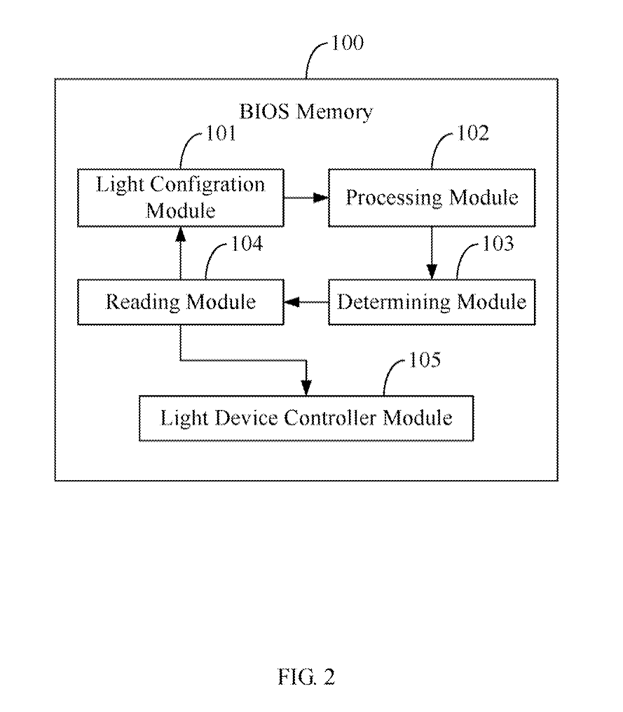

FIG. 2 is a schematic diagram of software function modules of the BIOS memory 100. The BIOS memory 100 mainly includes a light configuration module 101, a processing module 102, a determining module 103, a reading module 104, and a light device controller module 105.

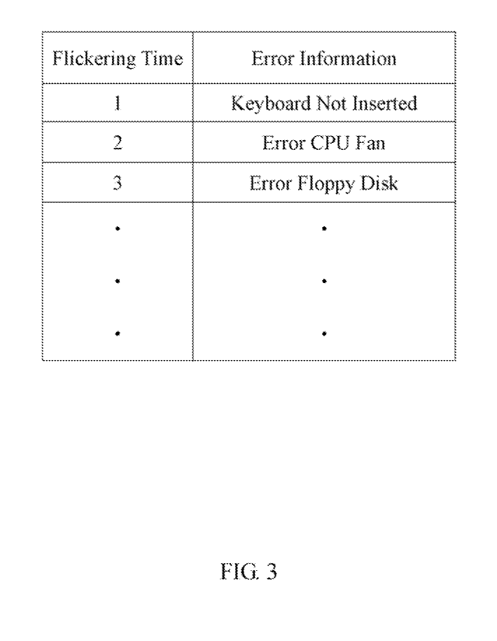

The light configuration module 101 is configured for setting a flicker count of the light device 20 for indicating different error types occurred on the motherboard 10. The light configuration module 101 is further configured for inserting the flicker count and the error types in an error information index as depicted in FIG. 3. FIG. 3 is a schematic diagram showing an error information index of the system of FIG. 1. The error types may include a keyboard error (when a keyboard is not attached to the computer 1), a central processing unit (CPU) fan error, and floppy disk error. For example, if the keyboard is not attached to the computer 1 properly, the light configuration module 101 sets the flicker count of the light device 20 to one; if the CPU fan has a fault, the light configuration module 101 sets the flicker count of the light device 20 to two; if the floppy disk has a fault, the light configuration module 101 sets the flicker count of the light device 20 to three, etc.

The BIOS memory 100 is used to provide a power-on self-test (POST) diagnostic program for the components and assemblies in the computer system when the computer system is booted. The computer 1 performs the POST to check that all the components and assemblies of the motherboard 10 are in good working order and operational, and the processing module 102 records status information of the motherboard 10 generated during the POST. The status information includes operational status information of all the components and assemblies of the motherboard 10. The status information may be stored in a complementary metal-oxide-semiconductor (CMOS) pin. The CMOS pin is a random access memory (RAM) pin, which is used for storing configuration information of the computer 1 and preconfigured parameters of the motherboard 10.

The processing module 102 is configured for resetting/clearing statuses information of the motherboard 10 generated during a previous POST.

The determining module 103 detects whether the computer 1 has finished performing the POST. The determining module 103 is further configured for detecting whether the motherboard 10 has any errors according to the status information of the motherboard 10. If the POST detects any errors of the motherboard 10, the reading module 104 is configured for reading information of the error and the corresponding flicker count from the error information index.

The light device controller module 105 is configured for controlling the light device 20 to flicker according to the flicker count read by the reading module 104. The operator can determine/derive the error component or assembly of the motherboard 10 according to the flicker count. For example, if the light device 20 flickers two times, it means that the CPU fan has an error.

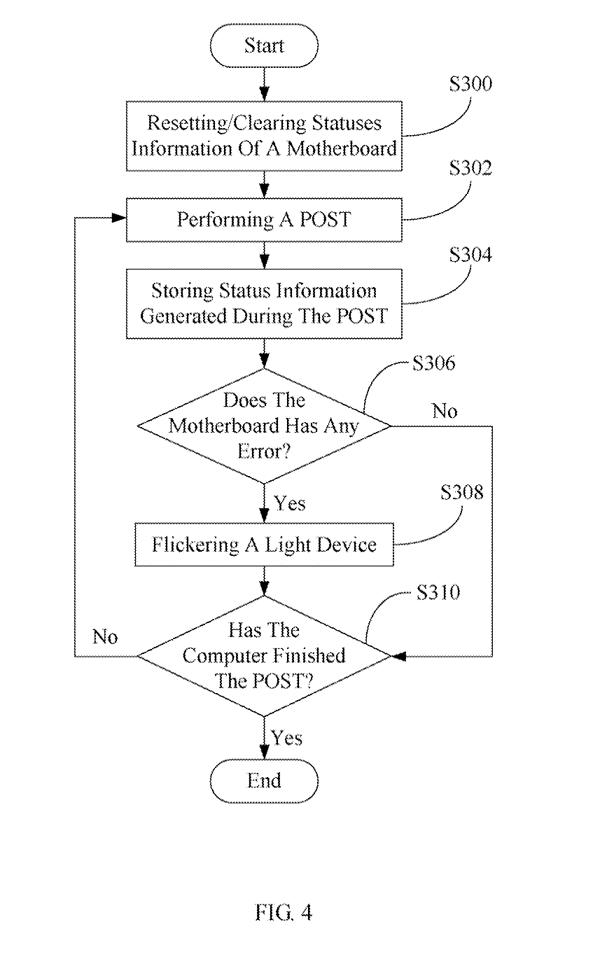

FIG. 4 is a flowchart of a preferred method for detecting and indicating errors of a motherboard in accordance with another embodiment. The light configuration module 101 can set the flicker count to the error types such as the component errors or the assembly errors of the motherboard 10 according to the requirement of the operator preliminarily, and insert all the error types of the motherboard 10 and the corresponding flicker count in the error information index.

In step S300, when the computer 1 is powered on, the processing module 102 resets/clears the statuses information of the motherboard 10 from the previous POST.

In step S302, the computer 1 performs the POST and checks all the components and assemblies of the motherboard 10.

In step S304, the processing module 102 records the status information of the motherboard 10 generated during the POST in the CMOS pin. The status information includes operational status information of all the components and assemblies of the motherboard 10.

In step S306, the determining module 103 detects whether the motherboard 10 has any error according to the POST process performed by the computer 1.

In step S308, the light device 20 flickers according to the flicker count if the motherboard 10 has any error. For example, if the CPU fan has any error, the light device 20 flickers two times set by the light configuration module 101.

In step S310, the determining module 103 determines whether the computer 1 has finished the POST, if the computer 1 has not finished the POST, the procedure returns to the step S302.

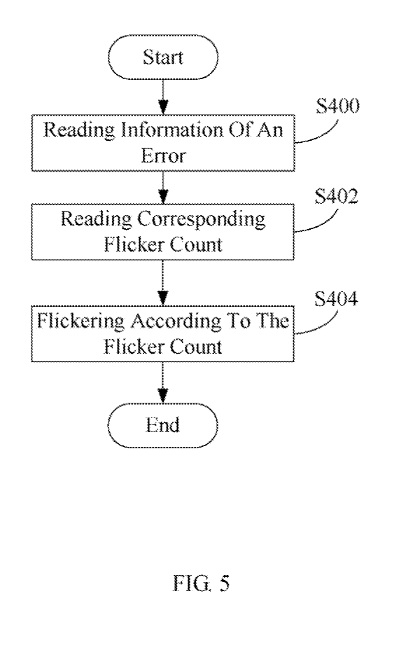

FIG. 5 is a flowchart of step S308 of FIG. 3 in detail, namely flickering according to the flicker count. In step S400, the reading module 104 reads information of the error of the motherboard 10 generated when the computer 1 performed the POST.

In step S402, the reading module 104 reads the flicker count corresponding to the error from the error information index.

In step S404, the light device controller module 105 controls the light device 20 to flicker according to the flicker count.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for indicating errors of a motherboard, the system comprising:
a light device electrically connected to the motherboard and configured for flickering when error occurs on the motherboard;
a light configuration module configured for setting a flicker count for indicating different error types occurred on the motherboard, and inserting the flicker count and corresponding error types in an error information index;
a processing module configured for resetting or clearing statuses information of the motherboard from the previous power-on self-test, performing a power-on self-test on the computer, and storing status information of the motherboard generated during the power-on self-test;
a determining module configured for detecting whether the motherboard has any error according to the status information of the motherboard;
a reading module configured for reading information of the error and the flicker count corresponding to the error from the error information index if the motherboard has any error; and
a light device controller module configured for controlling the light device to flicker according to the flicker count.

2. The system according to claim 1, wherein the processing module is further configured for storing the status information of the motherboard generated during the power-on self-test into a complementary metal-oxide-semiconductor pin.

3. The system according to claim 1, wherein the determining module is further configured for determining whether the computer has finished the power-on self-test.

4. The system according to claim 1, wherein the light configuration module, the processing module, the determining module, the reading module and the light device controller module are configured in a basic input/output system (BIOS) memory.

5. The system according to claim 1, wherein the light device is a power light.

6. A method for indicating errors of a motherboard, the method comprising:
setting a flicker count for indicating different error types occurred on a motherboard, and inserting the flicker count and corresponding error types in an error information index;
resetting or clearing statuses information of the motherboard from the previous power-on self-test within the computer;
performing a power-on self-test on the computer, and storing status information of the motherboard generated during the power-on self-test;
detecting whether the motherboard has any error according to the status information of the motherboard;
reading information of the error and corresponding flicker count from the error information index if the motherboard has any error; and
flickering a light device according to the flicker count.

7. The method according to claim 6, further comprising:
detecting whether the computer has finished the self-testing; and
returning to the step of performing the power-on self-test on the computer and storing the status information of the motherboard generated during the power-on self-test.

8. The method according to claim 6, wherein the status information of the motherboard generated during the power-on self-test is stored in a complementary metal-oxide-semiconductor pin.

9. The method according to claim 6, wherein the light device is a power light.
